(19) United States
(12) Patent Application Publication
(10) Pub. No.: US 2008/0314776 A1
(43) Pub. Date: Dec. 25, 2008

(54) Personalized nipple for use with bottles/pacifiers and associated method

(76) Inventor: Terry M. Cooke, Silver Spring, MD (US)

Correspondence Address: ASHKAN NAJAFI, P.A., 6817 SOUTHPOINT PARKWAY, SUITE 2301, JACKSONVILLE, FL, 32216, US

(21) Appl. No.: 12/002,493

(22) Filed: Dec. 18, 2007

Related U.S. Application Data
(60) Provisional application No. 60/936,689, filed on Jun. 22, 2007.

(51) Int. Cl. B65D 69/00; B29C 33/42

(52) U.S. Cl. 206/223; 264/222

(57) ABSTRACT

A kit includes materials for making a flexible replica including a first elastomer layer conformed to a shape of nipple and areola regions of the natural breast. The replica further includes a layer of elastic nylon mesh, a second elastomer layer situated over the elastic nylon mesh for creating a seamless impression replica of the nipple and areola regions. A layer of melted wax is coated against the inner surface of the first elastomer layer, and the second elastomeric layer is tinted to a distinct color for simulating an epidermal tissue color of the natural breast. The nipple region of the wax layer and the first and second elastomeric layers are provided with a plurality of orifices. The replica also contains an embossed serial number which identifies it with its owner.

### CROSS REFERENCE TO RELATED APPLICATIONS

This application claims the benefit of U.S. Provisional Application No. 60/936,689, filed Jun. 22, 2007, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a method for artificially creating replicas of human body parts, and more particularly to a kit for creating an artificial breast region simulated from a cast made to mimic a natural breast.

2. Prior Art

Natural breastfeeding is unquestionably the best way to nurture an infant. Among the many benefits of breastfeeding, the way an infant suckles on the breast is important to proper muscle, speech and dental development as well as psychological ‘bonding’ development. Not all mothers are able to nurse their infants. Non-nursing mothers who for whatever reason are unable to breast feed their infants often feel guilty or intimidated about the quality of their parenting. The concept of bottle-feeding their infants seems distant and impersonal. Of course, even nursing mothers sometimes need to leave their infants for a period of time, and may therefore miss a regularly scheduled feeding. In such situations, the nursing mother may choose to milk her breasts and leave the bottled food with a sitter. However, small babies often do not readily accept a bottle after having been nursed at the breast, regardless of the fact that the milk in the bottle is their own mother's milk. Therefore, it is likely that the shape and texture of the bottle nipple causes or at least contributes to the rejection.

U.S. Pat. No. 4,600,551 to Erb discloses a method for producing an external breast prosthesis or support by forming a mold directly from the subject for whom the prosthesis is being prepared. After a molding material is applied to the subject's breast, the breast is immersed in an isodensity liquid to present the breast to a zero-gravity condition while the molding material cures. Unfortunately, this prior art example is not designed for use as a bottle or pacifier.

U.S. Pat. No. 5,108,686 to Griffin discloses a nursing device with a nursing or pacifier nipple for use with nursing infants, and a method for manufacturing such articles. The device comprises an exact replica of the mother's nipple incorporated onto a bottle, specialized dispenser, or pacifier. The nursing device is formed from a mold taken of the nursing mother's natural breast and nipple. Unfortunately, this prior art example does not provide a do-it-yourself method for creating the device.

U.S. Pat. No. 6,343,704 to Prentiss discloses an artificial infant feeding nipple comprised of a hollow tubular fluid conduit having first and second open ends and a substantially transverse membrane closing the conduit. In the preferred embodiment, the membrane is perforated by a plurality of minimal diameter fluid apertures fully penetrating the membrane and extending beyond one face of the membrane within integrally formed hollow nubs having closed ends. Each closure nub is removable to permit fluid flow through the related aperture. Additionally, the recessed membrane provides reinforcing against collapse of the nipple tube while permitting the delivery end of the nipple to be plugged to prevent leakage when not in use. Unfortunately, this prior art example does not provide a replica of a mother's breast.

Accordingly, the present invention is disclosed in order to overcome the above noted shortcomings. The present invention is a do-it-yourself, convenient and easy to use, lightweight yet durable in design, and designed for creating an artificial breast region simulated from a natural breast. The kit is simple to use, inexpensive, and designed for many years of repeated use.

### BRIEF SUMMARY OF THE INVENTION

In view of the foregoing background, it is therefore an object of the present invention to provide a do-it-yourself apparatus for creating an artificial breast region simulated from a natural breast. These and other objects, features, and advantages of the invention are provided by a personalized nipple for use with bottles and pacifiers.

A kit includes materials for creating a plaster cast from which a flexible replica including a first elastomer layer is conformed to a shape of nipple and areola regions of the natural breast. The replica further includes a layer of elastic nylon mesh directly engaged against an outer surface of the elastomer layer to prevent premature tearing, and a second elastomer layer situated over the elastic nylon mesh for creating a seamless impression replica of the nipple and areola regions.

In an alternate and optional embodiment, a layer of melted wax is conveniently coated against the inner surface of the second elastomer layer. The second elastomeric layer is tinted to a distinct color for simulating epidermal tissue color of the natural breast. The nipple region of the wax layer and the first and second elastomeric layers are advantageously provided with a plurality of orifices in such a manner that the orifices pass through an entire thickness of the replica. Such orifices are formed within the top protrusion and spaced from the central region respectively.

All materials needed to make the mold come in the kit and may include instructions, an order form, skin prep pad, skin cleanser, nipple protectant, plaster casting strips or other materials necessary for molding a user breast, including a flesh-toned color palette.

The replica further includes a substantially dome-shaped central region and a rigid outer perimeter ring provided with a curvilinear shape contiguously extending about an entire circumference of the replica. Such an outer perimeter ring effectively has first and second orthogonally registered walls concentrically position about the central region. A centrally registered top protrusion is monolithically formed with the central region.

The kit further includes a skin color palette from which a layer of natural pigments are chosen, and applied later to the second elastomeric layer for conveniently providing coloration similar to the epidermal layer of the natural breast.

A method for forming a replica of the breast molded from a natural breast includes the steps of: making a 3-D mold of the patient's breasts by making a cast impression first, using the plaster cast strips, then filling the cast impression with a plaster-like substance which captures all the lines, dimples, etc. of the mother's real breasts. When this hardens/cures, it is removed from the cast. This is now the positive 3D model, or exact replica of the mother's breast, which can be sent from the physician's office to the nursing device manufacturer for production and stored for later use for future reproductions as needed.

Using the 3D mold, the manufacturer uses a medical grade silicone elastomer (soft, with skin-like elasticity and texture) which can be painted/applied over the model in 3 layers as described: coating a first layer of an elastomer onto the 3D breast mold; precisely spreading the first elastomer layer across nipple and areola regions of the 3D breast mold before the elastomer cures; while the first elastomer layer is seated on the 3D breast mold, applying a layer of an elastic nylon mesh on an outer surface of the first elastomer layer to prevent premature tearing; and while the first elastomer layer and the nylon mesh layer are seated on the 3D breast mold, applying a second layer of elastomer over the elastic nylon mesh for creating a seamless impression replica of the nipple and areola regions.

The method further includes the steps of: while the first and second elastomer layers and the nylon mesh layer are seated on the 3D breast mold, allowing the first and second elastomer layers to cure in room temperature; removing the replica from the 3D breast mold; layering an inner surface of the second elastomer layer with a layer of melted wax; allowing the wax layer to cure; tinting the second elastomer layer to a distinct color; and correcting defective curvatures of the second elastomer layer along the nipple and areola regions respectively.

The method further includes the steps of: creating a plurality of orifices directly into the nipple regions of the first and second elastomer layers as well as the wax layer; filling an elastomer substance into deep cracks formed in the areola and nipple regions that are in a vicinity of the orifices; and shave off undesirable protrusions from the nipple and areola regions.

The method further includes the steps of: applying natural cosmetic pigments to the second elastomer layer for providing coloration similar to the epidermal layer of the natural breast's nipple and areola regions; placing the replica in an elevated pressure compartment so that gases are eliminated from the replica prior to solidification thereof; manually agitating the first and second elastomer layers by hand along multiple planes; applying a volatile solvent onto the second elastomer layer.

Next, the device which has been painted is heat-cured, and then a layer of clear silicone is applied to seal in the tint. A unique serial number is embossed into the nipple or pacifier.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with nipple and particularity in the appended claims. The invention itself, however, both as to its organization and method of operation, together with further objects and advantages thereof, may best be understood by reference to the following description taken in connection with the accompanying drawings in which:

FIG. 1 is a perspective view showing a replica breast in use with a bottle, in accordance with the present invention;

FIG. 2 is a perspective view showing a replica breast used as a pacifier, in accordance with the present invention;

FIG. 3 is a cross sectional view of the replica, in accordance with the present invention; and

FIG. 4 is a perspective view of the replica, in accordance with the present invention.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

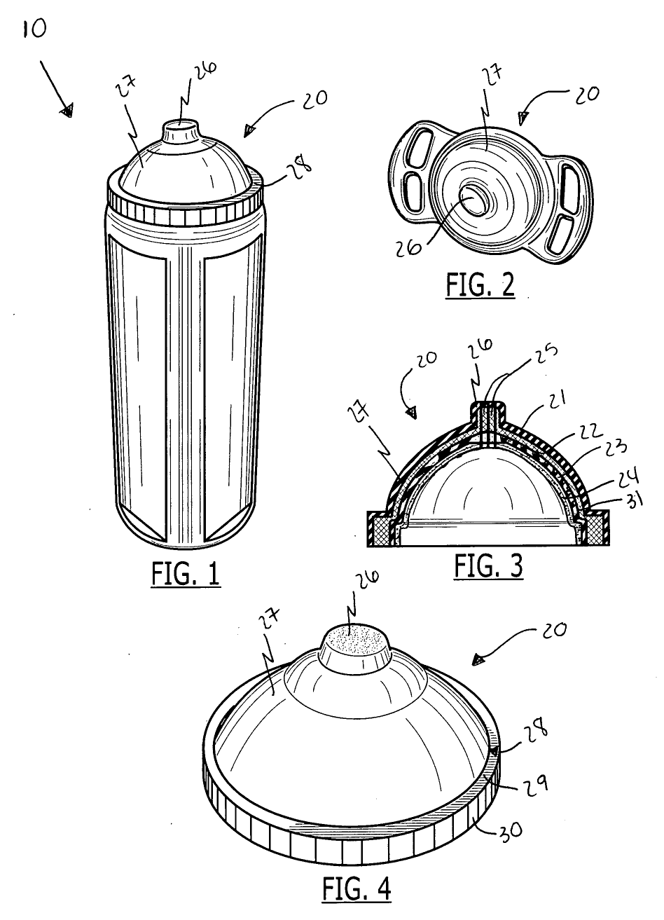

The apparatus and method of this invention is referred to generally in FIGS. 1-4 by the reference numeral 10 and is intended to provide a kit for forming a prosthetic breast molded from a natural breast. It should be understood that the apparatus 10 may be used to form many different types of molds for bottles and pacifiers and should not be limited to those molds mentioned herein.

Referring initially to FIGS. 1, 2, 3 and 4, a kit 10 includes materials for making a flexible replica 20 including a first elastomer layer 23 conformed to a shape of nipple and areola regions of the natural breast. The replica 20 further includes a layer of elastic nylon mesh 22 directly engaged, without the use of intervening elements, against an outer surface of the elastomer layer 23 to prevent premature tearing, and a second elastomer layer 21 situated over the elastic nylon mesh 22 for creating a seamless impression replica of the nipple and areola regions.

In an alternate and optional embodiment, a layer of melted wax 24 is coated against the inner surface of the second elastomer layer 21. The second elastomeric layer 21 is tinted to a distinct color for simulating an epidermal tissue color of the natural breast. The multiple layers provide a flexible yet durable replica.

Referring to FIG. 3, the nipple region of the wax layer 24 and the first and second elastomeric layers 23, 21 are provided with a plurality of orifices 25 in such a manner that the orifices 25 pass through an entire thickness of the replica 20. Such orifices 25 are formed within the top protrusion 26 and spaced from the central region respectively. The orifices 25 are provided for allowing milk to pass through the replica 20 and into a child's mouth.

Referring to FIGS. 1, 3 and 4, the replica 20 further includes a substantially dome-shaped central region 27 and a rigid outer perimeter ring 28 provided with a curvilinear shape contiguously extending about an entire circumference of the replica 20. Such an outer perimeter 28 has first and second orthogonally registered walls 29, 30 concentrically position about the central region 27. A centrally registered top protrusion 26 is monolithically formed with the central region 27. The walls 29, 30 are provided for supporting the replica on a bottle or pacifier.

Referring to FIG. 3, the kit 10 further includes a skin color palette from which a layer of natural pigments 31 are chosen to be applied to the second elastomeric layer 21, 23 for providing coloration similar to an epidermal layer of the natural breast. The pigments are provided for tinting the replica a color that resembles the color of the natural breast of the mother.

The kit includes materials for making a naturalistic replica of a mother's breast that offers parents a practical solution to nursing problems, providing a comfortable, naturalistic means of feeding the child when a mother is not able to nurse, while also avoiding the phenomenon of nipple confusion. Of course, the mimicked nipple could also include pacifiers, thus accommodating the infant child's non nutritional sucking needs, as is obvious to a person of ordinary skill in the art. A method for producing the nipple includes the step of making a 3D replica of either breast, in turn creating a mold from which a set of synthetic thermoplastic nipples are created. The molds are created under supervision in the office of the patient's physician in order to insure accuracy and safety. Each mold is custom crafted from the mother's own breasts, and is given a unique serial number which is embossed on the inner surface of the replica breast, thus the parent or caregiver can order additional nipples as needed.

Each nipple is realistically rendered in naturalistic flesh tones and is sized, shaped and gently contoured to mimic the human areola and nipple in a lifelike manner, identical to the mother's own breast. Further, like the human breast, formula (or milk) is dispensed through the nipple by a plurality of apertures formed across the surface of the areola.

All materials needed to make the mold come in the kit and may include instructions, an order form, skin prep pad, skin cleanser, nipple protectant, plaster casting strips or other materials necessary for molding a user breast, including a flesh-toned color palette.

The present invention, as claimed, provides the unexpected and unpredictable benefit of a method and kit for producing an infant feeding nipple mimicking a human nipple. The present invention provides an apparatus that is convenient and easy to use, is durable yet lightweight in design, and provides parents a simple and efficient means of ensuring their child will breast feed when needed. By eliminating the frustration and confusion so often associated with switching back and forth between the breast and a bottle, the innovative, naturalistic design of the present invention enables the child to receive nourishment in a more comfortable and relaxing manner. This advantage proves particularly beneficial when the nursing mother must leave her child in the care of a baby sitter, nanny or other child care provider, ensuring the child would not reject their bottle, simply because the nipple was unfamiliar and awkward to use.

In use, a method for forming a replica breast molded from a natural breast includes the steps of: making a 3-D model of the patient's breasts by making a cast impression first, then filling the cast impression with a plaster-like substance which captures all the lines, dimples, etc. of the mother's real breast. When this hardens/cures, remove it from the cast shell. This is now the positive 3-D model, or exact replica of the mother's breast, which can be stored for later use (future reproductions when needed).

Using the 3-D model, medical grade silicone elastomer (soft, with skin-like elasticity and texture) can be painted/applied over the 3D model in three layers as follows: coating a first layer of an elastomer 23 onto the 3D breast mold; precisely spreading the first elastomer layer 23 across nipple and areola regions of the 3D breast mold before the elastomer 23 cures; while the first elastomer layer 23 is seated on the 3D breast mold, applying a layer of an elastic nylon mesh 22 on an outer surface of the first elastomer layer 23 to prevent premature tearing; and while the first elastomer layer 23 and the nylon mesh layer 22 are seated on the 3D breast mold, applying a second layer of elastomer 21 over the elastic nylon mesh 22 for creating a seamless impression replica 20 of the nipple and areola regions.

In use, the method further includes the steps of: while the first and second elastomer layers 23, 21 and the nylon mesh layer 22 are seated on the 3D breast mold, allowing the first and second elastomer layers 23, 21 to cure in room temperature; removing the replica from the 3D breast mold; layering the inner surface of the first elastomer layer 23 with a layer of melted wax 24; allowing the wax layer 24 to cure; tinting the second elastomer layer 21 to a distinct color; and correcting defective curvatures of the second elastomer layer 21 along the nipple and areola regions respectively.

In use, the method further includes the steps of: creating a plurality of orifices 25 directly into the nipple region of the first and second elastomer layers 23, 21 as well as the wax layer 24; filling an elastomer substance into deep cracks formed in the areola and nipple regions that are in a vicinity of the orifices 25; and shaving off undesirable protrusions from the nipple and areola regions.

In use, the method further includes the steps of: placing the replica 20 in an elevated pressure compartment so that gases are eliminated from the replica 20 prior to solidification thereof; manually agitating the first and second elastomer layers 23, 21 by hand along multiple planes; applying a volatile solvent onto the second elastomer layer 21; blending organic pigments from the palette to match the various natural colors of the nipple and areola regions; selectively applying the organic pigments directly onto the nipple and areola regions of the second elastomer layer 21. Next, the device which has been painted is heat-cured, and then a layer of clear silicone is applied to seal in the tint. A unique serial number is embossed into the nipple or pacifier.

The apparatus and method 10 are achieved with this invention by forming a replica breast nipple modeled substantially from a natural breast nipple. In accordance with the invention, a thin coat of silicone or other elastomer is coated onto the 3D model of a replica breast nipple. Precise positioning of the nipple and areola elastomer is fixed precisely by the plaster cast used to form the breast mold.

Since silicone is relatively weak and tears, a layer of elastic nylon mesh is installed on the outer surface of the thin layer of silicone to prevent tear perpetuation. A subsequent and somewhat thicker layer of silicone is applied over the elastic nylon mesh and previous coat of material to result in a strong and seamless flexible impression of the nipple and areola in exact model positions being replicated.

The resulting flexible impression is used for production after curing of the silicone from the nipple and areola; tearing being prevented even with odd shapes by the incorporation of an elastic nylon mesh. The seamless, flexible impression is a replica which contains on its exterior and interior surfaces the finest details of the mother's natural breast which in the case of the nipple and areola thereof faithfully reproduces every detail of the nipple and areola including creases and skin texture.

The silicone replica is subsequently layered with melted wax whose excess is poured off after a layer 3 to 5 mm in thickness solidifies on the interior surface of the replica. This results in a combined thin wax shell and elastomeric body which is an exact model of the original natural breast nipple. It should be noted that an important advantage of this invention is that the elastomer model has the desired posture of the nipple and areola, since positioning of the nipple and areola which it duplicates was determined by the original plaster cast. This advantage is in contrast to the known human direct observation/judgment methods employed for correcting of the positioning of the nipple and areola.

The second elastomeric layer replica is tinted to a distinct color which will facilitate visualization of the fine surface details when the sculpturing of modifications is undertaken. Additionally, some of the silicone of the same batch and therefore same color, is poured to form a thin sheet of silicone which will be utilized in the subsequent sculpture and modifications of the nipple and areola. After warming, any desired small corrections of curvatures of the thin wax shells are made. By sculpturing techniques that are known, the model is expanded, contracted or otherwise modified according to the dimension and specific requirements of the desired usage. In embodiments where the nipple and areola being used for baby bottles the nipple and areola is provided with a plurality of orifices of maximum diameter to permit fluid flow of liquid out from the baby bottle, for example. Additionally, the areola surrounding the nipple is sculptured to have a high degree of definition, essential by subsequent precise cutting away of the surface composed of the smooth breast tissue. Areas of the nipple and areola having deep cracks in the vicinity of the orifices are partially filled-in to prevent the resulting passage of fluids from being excessively vulnerable to premature tearing. Undesirable protrusions present on the nipple and areola are shaved off the orifices which project outward from the nipple's outer surface.

In accordance with the invention, natural pigments are added to the second elastomer layer for providing a subtle tint adjusted to neutralize the gray hue characteristic of silicone. Thus, the liquid silicone remains translucent, but has coloration similar to the epidermal layer of all normal human skin.

In accordance with the invention, the replica is placed in an elevated pressure compartment so that gases are eliminated from the semi-liquid replica prior to solidification of the replica. This prevents the problem associated with known techniques with which liquid silicone or other elastomer dispersions are degassed in a separate container and subsequently poured into a desired mold. The latter known technique invariably results in the trapping of some air bubbles under the advancing lip of the poured material. Such air bubbles result in defects in the laminated layers of the prosthetic device rendering it imperfect.

After the pressuring procedure, the outer layer of the silicone replica is then agitated by hand along multiple planes. In a practicable embodiment of the inventive method, vibration is continued until there is sufficient settling of the first and second elastomeric layers as well as the wax layer to prevent shifting of the nipple region from a desired position on the areola region. This step gives a distribution of bubble-free silicone of equal thickness over all of the surfaces nipple and areola, respectively.

In accordance with a highly advantageous aspect of the invention, the subsequent silicone dispersions are tinted with other stable organic pigments with the extent of such tinting being carefully adjusted so that the overall coloration of the laminated silicone layers collectively matches the lightest skin color of the body nipple and areola of the mother for whom the device is being fabricated.

The final coloration is accomplished by working directly with the individual patient to ensure the prosthetic breast is positioned at a level corresponding to a heart level of the patient. As a major determinant of normal skin color of any nipple and areola is its blood content, which varies widely with its position in relation to the heart. This technique stabilizes the color being duplicated. Pigmented silicones are available in a kit and are applied to the deglazed surfaces of the cured and translucent, homogeneously-tinted silicone layers to match the individual characteristics of each patient. In one embodiment of the invention, silicone has been previously diluted with a volatile solvent into which are added stable organic pigments. The colors can be blended on the color palette, which is provided with the kit, to achieve the appropriate colors and tones required to match various areas of the nipple and areola. The patient chooses the desired colors and tones from the kit and the manufacturer will subsequently mix and apply the pigments appropriately.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In nipple and particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A kit for creating a cast from which a flexible 3D artificial replica breast mimicking a natural breast can be produced, said kit comprising:
a first elastomer layer conformed to a shape of nipple and areola regions of the natural breast;
a layer of elastic nylon mesh directly engaged against an outer surface of the elastomer layer to prevent premature tearing; and
a second elastomer layer situated over said elastic nylon mesh for creating a seamless impression replica of the nipple and areola regions.

2. The kit of claim 1, further comprising: a layer of melted wax coated against said inner surface of said first elastomer layer, wherein said second elastomeric layer is tinted to a distinct color for simulating an epidermal tissue color of the natural breast, and said wax layer has an embossed serial number engraved therein for identifying a manufacturing date and owner of said replica.

3. The kit of claim 1, wherein the nipple region of said wax layer and said first and second elastomeric layers are provided with a plurality of orifices in such a manner that said orifices pass through an entire thickness of the replica.

4. The kit of claim 3, further comprises: a skin-toned color palette from which a mother can select the color used for making a layer of natural pigments applied to said second elastomeric layer and for providing coloration similar to an epidermal layer of the natural breast.

5. The kit of claim 4, wherein said replica includes a substantially dome-shaped central region, a rigid outer perimeter provided with a curvilinear shape contiguously extending about an entire circumference of said replica, said outer perimeter having first and second orthogonally registered walls concentrically positioned about said central region, and a centrally registered top protrusion monolithically formed with said central region;
wherein said orifices are formed within said top protrusion and spaced from said central region respectively.

6. The kit of claim 5, wherein the nipple region of said wax layer and said first and second elastomeric layers are provided with a plurality of orifices in such a manner that said orifices pass through an entire thickness of the replica.

7. The kit of claim 6, further comprises: a skin color palette from which a layer of natural pigments are chosen to be applied to said second elastomeric layer for providing coloration similar to an epidermal layer of the natural breast.

8. A method for forming a prosthetic 3D replica breast molded from a cast mold of a natural breast, said method comprising the steps of:
a. coating a first layer of an elastomer onto the cast mold of the natural breast;
b. precisely spreading the first elastomer layer across nipple and areola regions of the cast mold of the natural breast before the elastomer cures;
c. while said first elastomer layer is seated on the cast of the natural breast, applying a layer of an elastic nylon mesh on an outer surface of the first elastomer layer to prevent premature tearing; and
d. while said first elastomer layer and said nylon mesh layer are seated on the cast mold of the natural breast, applying a second layer of elastomer over the elastic nylon mesh for creating a seamless replica of the nipple and areola regions.

9. The method of claim 8, further comprising the step of:
e. engraving an embossed serial number into said wax layer for identifying a manufacturing date and an owner of said replica.

10. The method of claim 9, further comprising the steps of:
f. while said first and second elastomer layers and said nylon mesh layer are seated on the cast mold, allowing said first and second elastomer layers to cure in room temperature;
g. removing said replica from the cast mold;
h. layering an inner surface of said first elastomer layer with a layer of melted wax;
i. allowing said wax layer to cure;
j. tinting said second elastomer layer to a distinct color; and
k. correcting defective curvatures of said second elastomer layer along the nipple and areola regions respectively.

11. The method of claim 10, further comprising the steps of:
l. creating a plurality of orifices directly into said nipple and areola regions of said first and second elastomer layers as well as said wax layer;
m. filling an elastomer substance into deep cracks formed in said areola and nipple regions that are in a vicinity of said orifices; and
n. shaving off undesirable protrusions from said nipple and areola regions.

12. The method of claim 10, further comprising the steps of:
o. applying natural pigments to said second elastomer layer for providing coloration similar to an epidermal layer of the natural breast;
p. placing said replica in an elevated pressure compartment so that gases are eliminated from said replica prior to solidification thereof;
q. manually agitating said first and second elastomer layers by hand along multiple planes;
r. applying a volatile solvent onto said second elastomer layer;
s. blending organic pigments on a palate to match various natural colors of said nipple and areola regions; and
t. selectively applying said organic pigments directly onto said nipple and areola regions of said second elastomer layer.
